(19) United States
(12) Patent Application Publication
(10) Pub. No.: US 2025/0249726 A1
(43) Pub. Date: Aug. 7, 2025

(54) AIR CONDITIONING SYSTEM

(71) Applicant: NGK INSULATORS, LTD., Nagoya-City (JP)

(72) Inventors: Yoshiki KONNO, Tajimi-Shi (JP); Hirotaka SAITO, Konan-Shi (JP)

(73) Assignee: NGK INSULATORS, LTD., Nagoya-City (JP)

(21) Appl. No.: 18/969,549

(22) Filed: Dec. 5, 2024

(30) Foreign Application Priority Data
Feb. 1, 2024 (JP) 2024-014392

(51) Int. Cl. B60H 1/00; F25B 30/02; F25B 49/02

(52) U.S. Cl. CPC B60H 1/00899; F25B 30/02; F25B 49/02

(57) ABSTRACT

An air conditioning system including a heat pump cycle having a refrigerant pipe capable of circulating a refrigerant therethrough, and a compressor capable of compressing the refrigerant. The air conditioning system is provided with at least one heating portion capable of heating the refrigerant in the refrigerant pipe on an upstream side, a downstream side, or both of the upstream side and the downstream side of the compressor based on a flow direction of the refrigerant. The heating portion includes: a honeycomb structure having an outer peripheral wall and partition walls disposed on an inner side of the outer peripheral wall, the partition walls defining a plurality of cells, each of the cells extending from a first end face to a second end face, at least the partition walls being made of a material having a PTC property.

### CROSS REFERENCE TO RELATED APPLICATIONS

The present invention claims the benefit of priority to Japanese Patent Application No 2024-014392 filed on Feb. 1, 2024 with the Japanese Patent Office, the entire contents of which are incorporated herein by reference in its entirety.

### FIELD OF THE INVENTION

The present invention relates to an air conditioning system.

### BACKGROUND OF THE INVENTION

There is known an air conditioning system capable of cooling and heating using a heat pump cycle. The air conditioning system has advantages such as power saving, and is therefore also used in vehicles such as battery electric vehicles (BEVs). The heat pump cycle has a structure in which components such as a compressor, a condenser, an evaporator, and an expansion valve(s) are connected in a ring shape by a refrigerant pipe, and can perform cooling and heating by utilizing the heat of vaporization and condensation of the refrigerant.

However, the air conditioning system that uses the heat pump cycle have a problem of decreasing initial heating performance in cold weather (start of heating is slower) because it converts outside air to heat. Specifically, in cold weather, the temperature of the refrigerant flowing through the heat pump cycle is lower, so that the temperature and pressure of the refrigerant do not increase easily upon the start of heating. It results in slow start of heating and takes a long period of time to feed warm air.

To solve this problem, Patent Literature 1 proposes an air conditioning system (vehicle air conditioner) that controls an amount of air sent to a vehicle interior heat exchanger, which acts as a radiator, to decrease upon the start of heating. Patent Literature 2 also proposes an air conditioning system (vehicle air conditioner) that increases an amount of heat of a refrigerant by a refrigerant heater to speed up the start of heating.

However, the air conditioning system of Patent Literature 1 reduces the amount of air sent to the radiator (vehicle interior heat exchanger) upon the start of heating, thereby reducing the amount of heat exchanged between the refrigerant discharged from the compressor and the outside air as the refrigerant flows through the radiator to facilitate the increase in the temperature of the refrigerant. However, since it does not heat the refrigerant, the initial heating performance cannot be sufficient.

Also, the air conditioning system of Patent Literature 2 heats the refrigerant with a refrigerant heater composed of a sheathed heater (electric heater), which results in high power consumption. For this reason, for example, if the air conditioning system is used in an electric vehicle, there is a problem that the driving range is significantly reduced due to energy loss.

The present invention was made to solve the problems as described above. An object of the present invention is to provide an air conditioning system capable of improving initial heating performance while suppressing power consumption.

### PRIOR ART

### Patent Literatures

[Patent Literature 1] Japanese Patent Application Publication No. 2014-24371 A
[Patent Literature 2] Japanese Patent Application Publication No. 2014-131914 A

### SUMMARY OF THE INVENTION

As a result of intensive studies for air conditioning systems using heat pump cycles, the present inventors have found that the above problems can be solved by providing a predetermined heating portion in a refrigerant pipe through which the refrigerant flows and heating the refrigerant, and they have completed the present invention. That is, the present invention is illustrated as follows:

[1]

An air conditioning system comprising a heat pump cycle having a refrigerant pipe capable of circulating a refrigerant therethrough, and a compressor capable of compressing the refrigerant, wherein:
the air conditioning system is provided with at least one heating portion capable of heating the refrigerant in the refrigerant pipe on an upstream side, a downstream side, or both of the upstream side and the downstream side of the compressor based on a flow direction of the refrigerant; and
the heating portion comprises: a honeycomb structure having an outer peripheral wall and partition walls disposed on an inner side of the outer peripheral wall, the partition walls defining a plurality of cells, each of the cells extending from a first end face to a second end face, at least the partition walls being made of a material having a PTC property.
   [2]

The air conditioning system according to [1], wherein the air conditioning system further comprises a control unit for controlling the heat pump cycle and the heating portion, and wherein the control unit comprises controlling so as to apply a voltage to the honeycomb structure to heat the refrigerant upon start of a heating operation mode of the heat pump cycle.

[3]

The air conditioning system according to [2],
wherein the heat pump cycle further comprises a condenser for exchanging heat between air flowing through an air conditioning duct and the refrigerant, and
wherein the heating operation mode comprises compressing the refrigerant by the compressor and introducing the refrigerant discharged from the compressor into the condenser to heat the air.
   [4]

The air conditioning system according to any one of [1] to [3], wherein the heat pump cycle further comprises:
an evaporator for exchanging heat between the air flowing through the air conditioning duct and the refrigerant; and
an outdoor heat exchanger for exchanging heat between outside air and the refrigerant.
   [5]

The air conditioning system according to [4], wherein the heating portion is provided in the refrigerant pipe at a position between the compressor and the condenser, or at a position between the compressor and the evaporator or the outdoor heat exchanger, or the heat portions are provided in the refrigerant pipe at both positions.

[6]

The air conditioning system according to any one of [1] to [5], wherein the material having the PTC property comprises barium titanate as a main component.

[7]

The air conditioning system according to any one of [1] to [6], wherein the air conditioning system is for a vehicle.

### BRIEF DESCRIPTION OF THE DRAWINGS

FIG. 1A is a schematic configuration view of a vehicle air conditioning system according to an embodiment of the present invention, which shows an operating state during a heating operation mode;

FIG. 1B is a schematic configuration view of a vehicle air conditioning system according to an embodiment of the present invention, which shows an operating state during a cooling operation mode;

FIG. 1C is a schematic configuration view of a vehicle air conditioning system according to an embodiment of the present invention, which shows an operating state during another cooling operation mode;

FIG. 2A is a schematic cross-sectional sectional view of a heating portion used in an air conditioning system according to an embodiment of the present invention, which is parallel to an extending direction of cells;

FIG. 2B is a schematic cross-sectional view of the heating portion taken along the line a-a′ in FIG. 2A;

FIG. 3A is a schematic cross-sectional view of another heating portion used in an air conditioning system according to an embodiment of the present invention, which is parallel to an extending direction of cells; and

FIG. 3B is a schematic cross-sectional view of the heating portion in FIG. 3A taken along the line b-b′.

### DETAILED DESCRIPTION OF THE INVENTION

An air conditioning system according to the present invention includes a heat pump cycle having a refrigerant pipe capable of circulating a refrigerant therethrough and a compressor capable of compressing the refrigerant, wherein the air conditioning system is provided with a heating portion capable of heating the refrigerant in the refrigerant pipe on an upstream side, a downstream side, or both of the upstream side and the downstream side of the compressor based on a flow direction of the refrigerant. The heating portion includes: a honeycomb structure having an outer peripheral wall and partition walls disposed on an inner side of the outer peripheral wall, the partition walls defining a plurality of cells, each of the cells extending from a first end face to a second end face, at least the partition walls being made of a material having a PTC (Positive Temperature Coefficient) property. With such a structure, the air conditioning system according to the present invention can rapidly heat the refrigerant in cold weather, so that initial heating performance can be improved. Also, the air conditioning system according to the present invention can reduce power consumption as compared to air conditioning systems that use conventional sheathed heaters (electric heaters) to heat the refrigerant, so that it leads to energy savings and, particularly when applied to electric vehicles, the driving range can be extended.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

The air conditioning system according to the present invention can be used in various facilities and products that require air conditioning. For example, the air conditioning system according to the present invention can be used in air conditioners used in offices and homes, home appliances such as refrigerators and washer-dryers, and various vehicles such as automobiles. Among them, the air conditioning system according to the present invention is suitable for use in various vehicles such as automobiles. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The vehicle air conditioning system according to the embodiment of the present invention can be particularly suitably used for a vehicle having no internal combustion engine such as electric vehicles and electric railcars.

It should be noted that in the following descriptions, air conditioning systems for use in vehicles will be described as an example, but, needless to say, the present invention can also be used in the various facilities and products as described above.

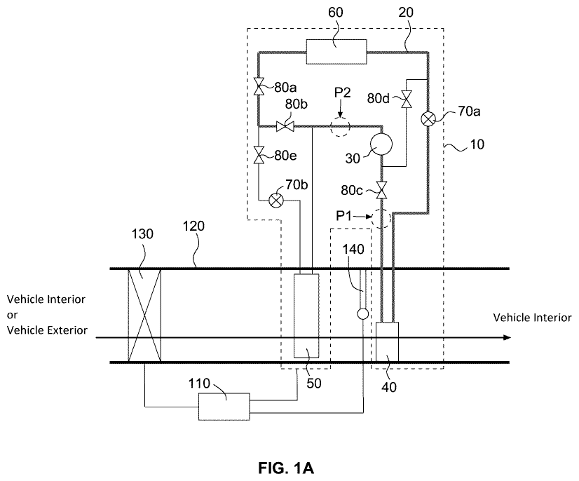

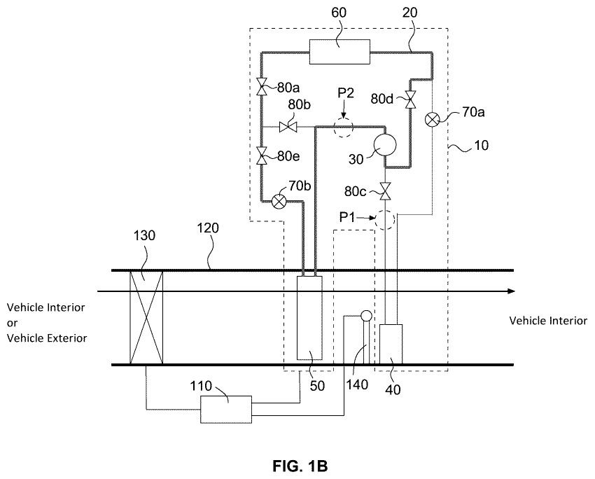

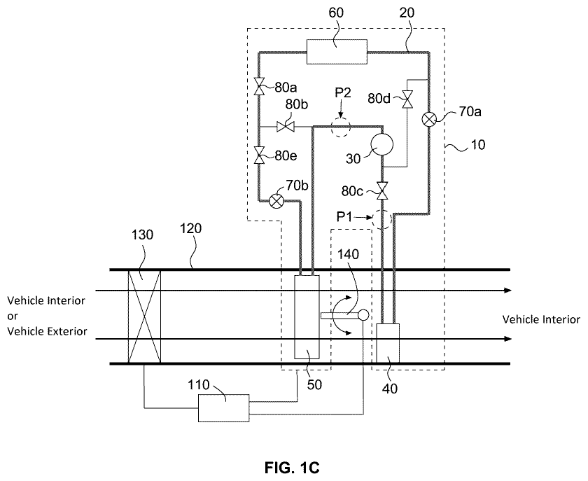

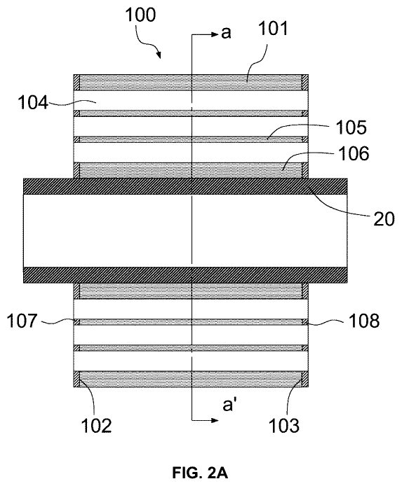

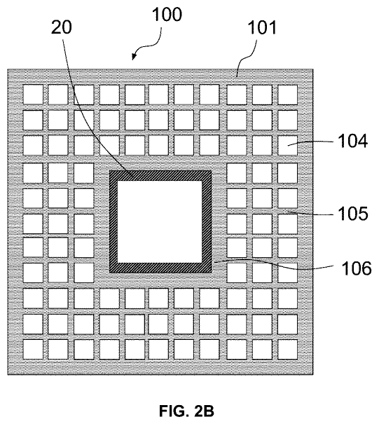

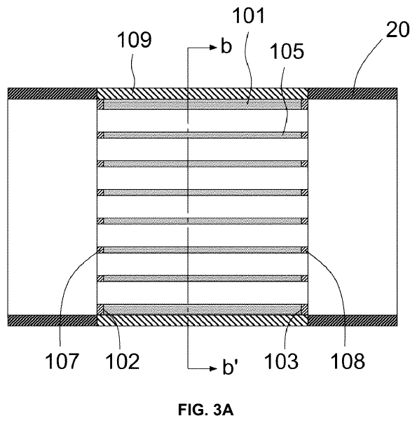

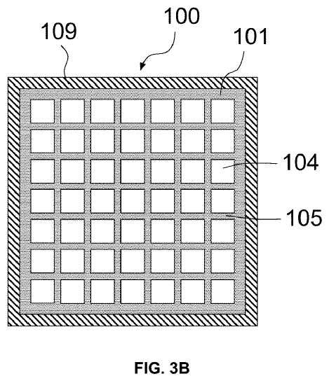

Each of FIGS. 1A and 1B is a schematic configuration view of an air conditioning system according to an embodiment of the present invention, which shows an operation state during each operation mode. In particular, FIG. 1A is the heating operation mode, FIGS. 1B and 1C are the cooling operation mode. FIG. 2A is a schematic cross-section view of a heating portion used in an air conditioning system according to an embodiment of the present invention, which is parallel to an extending direction of cells. FIG. 2B is a schematic cross-sectional view of the heating portion taken along the line a-a′ in FIG. 2A. FIG. 3A is a schematic cross-sectional view of another heating portion used in the air conditioning system according to an embodiment, which is parallel to an extending direction of cells. FIG. 3B is a schematic cross-sectional view of the heating portion in FIG. 3A taken along the line b-b′.

The air conditioning system according to an embodiment of the present invention includes: a heat pump cycle 10; and a heating portion 100. Also, the air conditioning system can further include: a control unit 110; an air conditioning duct 120; a ventilation fan 130; and an air mix door 140.

Hereinafter, each of these components will be described in detail.

### (1. Heat Pump Cycle 10)

The heat pump cycle 10 has a refrigerant pipe 20 and a compressor 30. The structure of the heat pump cycle 10 is not particularly limited and a known structure can be adopted, as long as the heat pump cycle 10 has those components. For example, the heat pump cycle 10 can further have a condenser 40, an evaporator 50, an outdoor heat exchanger 60, expansion valves 70a, 70b, and shut-off valves 80a to 80e. The condenser 40 and the evaporator 50 are provided in the air conditioning duct 120.

The refrigerant pipe 20 is a component through which the refrigerant can circulate, and connects various components such as the compressor 30 and condenser 40.

The compressor 30 is a component that can compress the refrigerant.

Specifically, the compressor 30 is driven by the control unit 110, and compresses the refrigerant, thereby discharging a high-temperature, high-pressure refrigerant to the condenser 40.

In addition, a known device such as a gas-liquid separator may be provided on an upstream side of the compressor 30.

The condenser 40 is a component that exchanges heat between the air flowing through the air conditioning duct 120 and the refrigerant. Specifically, when the heating operation mode is performed, the condenser 40 is capable of dissipating heat using the high-temperature, high-pressure refrigerant flowing inside, and heats the air around the condenser 40 flowing through the air conditioning duct 120.

The evaporator 50 is also a component that exchanges heat between the air flowing through the air conditioning duct 120 and the refrigerant. Specifically, when the cooling operation mode is performed, the evaporator 50 is capable of absorbing heat using the low-temperature, low-pressure refrigerant flowing inside, and cools the air around the evaporator 50 flowing through the air conditioning duct 120.

The outdoor heat exchanger 60 is a component that exchanges heat between the outside air and the refrigerant. The outdoor heat exchanger 60 is capable of absorbing the heat from the outside air using a low-temperature, low-pressure refrigerant flowing inside, and vaporizes the refrigerant by absorbing the heat from the outside air, mainly when executing the heating operation mode. Moreover, the outdoor heat exchanger 60 can release the heat to the outside air by the high-temperature, high-pressure refrigerant flowing inside, and cools the refrigerant by releasing the heat to the outside air, mainly when executing the cooling operation mode.

The expansion valves 70a, 70b are throttle valves whose opening degrees can be adjusted by the control unit 110. In particular, when the heating operation mode is executed, the expansion valve 70a reduces the pressure of the refrigerant discharged from the condenser 40 to expand it, and then discharges the low-temperature, low-pressure refrigerant to the outdoor heat exchanger 60. Furthermore, when the cooling operation mode is executed, the expansion valve 70b reduces the pressure of the refrigerant from the outdoor heat exchanger 60 to expand it, and then discharge the low-temperature, low-pressure refrigerant to the evaporator 50.

The shutoff valves 80a to 80e are provided to control the flow path of the refrigerant. The opening and closing of the shutoff valves 80a to 80e are controlled by the control unit 110.

(2. Heating Portion 100)

The heating portion 100 is provided in the refrigerant pipe 20 on the upstream side, a downstream side, or both of the upstream and the downstream sides of the compressor 30, based on the flow direction of the refrigerant. For example, in the air conditioning system shown in FIGS. 1A and 1B, the heating portion 100 can be provided in the refrigerant pipe 20 between the compressor 30 and the condenser 40 (e.g., at a position P1), between the compressor 30 and the evaporator 50 or the outdoor heat exchanger 60 (e.g., at a position P2), or at both of the positions (e.g., at positions P1 and P2). By arranging the heating portion(s) 100 at such a position(s), the refrigerant can be rapidly heated in cold weather, so that the initial heating performance can be improved.

The heating portion 100 includes: a honeycomb structure including: an outer peripheral wall 101 and partition walls 105 that are disposed on an inner side of the outer peripheral wall 101 and define a plurality of cells 104 each extending from a first end face 102 to a second end face 103, wherein at least the partition walls 105 are made of a material having a PTC property. By using the heating portion 100 having such a honeycomb structure, power consumption can be reduced as compared to a conventional sheathed heater (electric heater).

The method of providing the heating portion 100 in the refrigerant pipe 20 is not particularly limited, and may be an indirect heating method in which the heating portion 100 is disposed around the refrigerant pipe 20 and the refrigerant is indirectly heated via heating of the refrigerant pipe 20, or a direct heating method in which the heating portion 100 is disposed in the middle of the refrigerant pipe 20 and the refrigerant is directly heated. Among these methods, the direct heating method is preferable from the viewpoint of a heating efficiency.

For of the indirect heating method, for example, as shown in FIGS. 2A and 2B, the periphery of the refrigerant pipe 20 can be covered with the honeycomb structure. In this case, the honeycomb structure may further have an inner peripheral wall 106, and the inner peripheral wall 106 may be provided so as to be in contact with the refrigerant pipe 20. Alternatively, although not shown, the outer peripheral wall 101 of the honeycomb structure may be provided so as to be in contact with the refrigerant pipe 20. In this case, the honeycomb structure may not have the inner peripheral wall 106. Also, the honeycomb structure may be configured so that the honeycomb structure and the refrigerant pipe 20 are not in contact with each other, and the air heated by the honeycomb structure is brought into contact with the refrigerant pipe 20.

For the direct heating method, as shown in FIGS. 3A and 3B, the heating portion 100 including the honeycomb structure and an outer cylindrical member 109 covering the periphery of the outer peripheral wall 101 of the honeycomb structure may be disposed in the middle of the refrigerant pipe 20 so that the refrigerant flows through the cells 104. In this case, the method of connecting the refrigerant pipe 20 to the heating portion 100 is not particularly limited, and the outer cylindrical member 109 and the refrigerant pipe 20 may be connected to each other by a known method such as bolts or welding.

The shape of the honeycomb structure is not particularly limited. For example, an outer shape of a cross section of the honeycomb structure orthogonal to the extending direction of the cells 104 of the honeycomb structure can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 102 and second end face 103) have the same shape as the cross section. Also, when the cross section and the end faces are polygonal, the corners may be chamfered.

The shape of each cell 104 is not particularly limited, but it may be polygonal such as quadrangular, pentagonal, hexagonal, heptagonal, and octagonal, circular, or oval in the cross section of the honeycomb structure orthogonal to the extending direction of the cells 104. These shapes may be alone or in combination of two or more. Moreover, among these shapes, the quadrangle or the hexagon is preferable.

The honeycomb structure may be a honeycomb joined body having a plurality of honeycomb segments and joining layers that join outer peripheral side surfaces of the plurality of honeycomb segments together. The use of the honeycomb joined body can increase the total cross-sectional area of the cells 104, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having the PTC property, or may contain the same material as the outer peripheral wall 101 and the partition walls 105. In addition to the role of joining the honeycomb segments to each other, the joining material can also be used as an outer peripheral coating material after joining the honeycomb segments.

Each thickness of the outer peripheral wall 101 and the inner peripheral wall 106 are not particularly limited, but it may preferably be 0.2 to 0.8 mm. The thickness of each of the outer peripheral wall 101 and the inner peripheral wall 106 of 0.2 mm or more allows the strength of the honeycomb structure to be ensured. Furthermore, the thickness of each of the outer peripheral wall 101 and the inner peripheral wall 106 of 0.8 mm or less allows the electrical resistance to be increased and the initial current to be suppressed.

As used herein, the thickness of the outer peripheral wall 101 refers to a length in the normal direction from a boundary between the outer peripheral wall 101 and the outermost cell 104 or partition wall 105 to the outer surface of the honeycomb structure in a cross section orthogonal to the extending direction of the cells 104. Similarly, the thickness of the inner peripheral wall 106 refers to a length in the normal direction from a boundary between the inner peripheral wall 106 and the innermost cell 104 or partition wall 105 to the inner surface of the honeycomb structure in the same cross section.

The thickness of the partition walls 105 is not particularly limited, but it may preferably be 0.01 to 0.3 mm, more preferably 0.02 to 0.2 mm, and even more preferably 0.03 to 0.1 mm. By controlling the thickness of the partition wall 105 within such a range, the strength of the honeycomb structure can be ensured.

As used herein, the thickness of the partition walls 105 refers to a length of a line segment that crosses the partition wall 105 when the line segment connects the centers of gravity of adjacent cells 104 in a cross section orthogonal to the extending direction of the cells 104. The thickness of the partition walls 105 refers to an average thickness of all the partition walls 105.

The cell density is not particularly limited, but it may preferably be 30 to 100 cells/cm², more preferably 35 to 70 cells/cm², and further preferably 40 to 65 cells/cm². By controlling the cell density within such a range, the strength of the honeycomb structure can be ensured.

As used herein, the cell density refers a value obtained by dividing a number of cells by an area of one end face (first end face 102 or second end face 103) of the honeycomb structure (the total area of the partition walls 105 and the cells 104 excluding the outer peripheral wall 101).

The cell pitch is not particularly limited, but it may preferably be 1.0 to 2.0 mm, more preferably 1.2 to 1.8 mm, and further preferably 1.3 to 1.6 mm or more. By controlling the cell pitch within such a range, the strength of the honeycomb structure can be ensured.

As used herein, the cell pitch refers to a value obtained by the following calculation. First, the area of one end face (first end face 102 or second end face 103) of the honeycomb structure (the total area of the partition walls 105 and the cells 104 excluding the outer peripheral wall 101) is divided by the number of the cells to calculate an area per a cell. A square root of the area per a cell is then calculated, and this is determined to be the cell pitch.

The length in the extending direction of the cells 104 and the cross-sectional area orthogonal to the flow path direction of the honeycomb structure may be adjusted according to the required size of the heating portion 100, and are not particularly limited. For example, when used in a compact heating portion 100 while ensuring a predetermined function, the honeycomb structure can have a length of 2 to 20 mm in the extending direction of the cells 104 and a cross-sectional area of 10 cm² or more orthogonal to that direction. Although the upper limit of the cross-sectional area orthogonal to the extending direction of the cells 104 is not particularly limited, it is, for example, 300 cm².

The partition walls 105 forming the honeycomb structure are made of a material that can be heated by electric conduction, specifically made of a material having the PTC property. Further, the outer peripheral wall 101 and the inner peripheral wall 106 may also be made of the material having the PTC property, as with the partition walls 105, as needed. By such a configuration, the refrigerant flowing through the refrigerant pipe 20 can be directly heated by heat transfer from the heat-generating partition walls 105. Further, the material having the PTC property has characteristics such that when the temperature increases to exceed the Curie point, the resistance value is sharply increased, resulting in a difficulty for electricity to flow. Therefore, when the temperature of the partition walls 105 becomes high, the current flowing through them is limited, thereby suppressing excessive heat generation of the honeycomb structure.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271:2008.

From the viewpoints that can be heated by electric conduction and has the PTC property, the material having the PTC property preferably contains barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the material having the PTC property is substantially free of lead (Pb). More particularly, the material having the PTC property preferably has a Pb content of 0.01% by mass or less, and more preferably 0.001% by mass or less, and still more preferably 0% by mass. In the material having the PTC property, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material having the PTC property preferably has a Curie point in a temperature range where the resistance value becomes twice or more the resistance at room temperature (25° C.). If the Curie point is in such a temperature range, the current flowing through the heating portion 100 is limited when the honeycomb structure reaches a high temperature, so that excessive heat generation of the heating portion 100 is efficiently suppressed.

The material having the PTC property preferably has a lower limit of a Curie point of 80° C. or more, and more preferably 100° C. or more, and even more preferably 110° C. or more, and still more preferably 125° C. or more, in terms of efficiently heating the refrigerant. Further, the upper limit of the Curie point is preferably 200° C. or more, and preferably 190° C. or more, and even more preferably 180° C. or more, and particularly preferably 150° C. or more, in terms of safety as a component of the air conditioning system.

The Curie point of the material having the PTC property can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

The honeycomb structure may include a pair of electrodes 107, 108 as shown in FIG. 2A. The pair of electrodes 107, 108 can be provided on the first end face 102 and the second end face 103, as illustrated in FIG. 2A. Furthermore, the pair of electrodes 107, 108 may be disposed on the outer peripheral wall 101 parallel to the extending direction of the cells 104.

Applying of a voltage between the pair of electrodes 107, 108 allows the honeycomb structure to generate heat by Joule heat.

The pair of electrodes 107, 108 may employ, for example, a metal or alloy containing at least one selected from Cu, Ag, Al, Ni and Si, although not particularly limited thereto. It is also possible to use an ohmic electrode capable of ohmic contact with the outer peripheral wall 101, the partition walls 105 and the like which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 107, 108 may have a single-layer structure, or may have a laminated structure of two or more layers. When the pair of electrodes 107, 108 have the laminated structure of two or more layers, the materials of the respective layers may be of the same type or of different types.

The thickness of the pair of electrodes 107, 108 may be appropriately set according to the method for forming the pair of electrodes 107, 108. The method for forming the pair of electrodes 107, 108 includes metal deposition methods such as sputtering, vapor deposition, electrolytic deposition, and chemical deposition. Alternatively, the pair of electrodes 107, 108 can be formed by applying an electrode paste and then baking it, or by thermal spraying. Furthermore, the pair of electrodes 107, 108 may be formed by joining metal sheets or alloy sheets.

Each of the thicknesses of the pair of electrodes 107, 108 is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

The honeycomb structure may further be provided with terminals connected to the pair of electrodes 107, 108. The provision of the terminals facilitates connection to an external power source.

The terminals may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

Furthermore, the thickness of the terminal is not particularly limited, but it is, for example, 0.01 to 10 mm, typically 0.05 to 5 mm.

The method of connecting the terminals to the pair of electrodes 107, 108 is not particularly limited as long as they are electrically connected. For example, they can be connected by diffusion bonding, a mechanical pressing mechanism, welding, or the like.

The method for producing the honeycomb structure making up the heating portion 100 is not particularly limited, and it can be performed according to a known method. Hereinafter, the typical method for producing the honeycomb structure will be illustratively described.

A method for producing the honeycomb structure includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, thickness of each portion, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

On the honeycomb structure thus obtained, the pair of electrodes 107, 108 are formed. The pair of electrodes 107, 108 can be formed by metal deposition methods such as sputtering, vapor deposition, electrolytic deposition, and chemical deposition. Further, the pair of electrodes 107, 108 can also be formed by applying an electrode paste and then baking it. Furthermore, the pair of electrodes 107, 108 can also be formed by thermal spraying. The pair of electrodes 107, 108 may be composed of a single layer, but may also be composed of a plurality of electrode layers having different compositions. A typical method for forming the pair of electrodes 107, 108 will be described below.

First, an electrode slurry containing an electrode material, an organic binder, and a dispersion medium is prepared, and the first end face 102 or the second end face 103 of the honeycomb structure is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure is removed by blowing and wiping. The slurry can be then dried to form the pair of electrodes 107, 108 on the first end face 102 or the second end face 103 of the honeycomb structure. The drying can be performed while heating the vehicle air conditioning system to a temperature of about 120 to 600° C., for example. Although a series of steps of coating, slurry removal, and drying may be performed only once, the steps can be repeated multiple times to provide the pair of electrodes 107, 108 having desired thicknesses.

When the terminals are provided, they are then disposed at predetermined positions of the pair of electrodes 107, 108, and the pair of electrodes 107, 108 and the terminals are connected to each other. As a method of connecting the pair of electrodes 107, 108 to the terminals, the method described above can be used.

### (3. Control Unit 110)

The control unit 110 controls the heating portion 100 and the heat pump cycle 10 depending on the operation mode. The control unit 110 is electrically connected to the heat pump cycle 10 and the heating portion 100. Specifically, the control unit 110 is electrically connected to the shutoff valves 80a to 80e of the heat pump cycle 10, and can control the refrigerant flow path by opening and closing the shutoff valves 80a to 80e. Further, the control unit 110 is electrically connected to the expansion valves 70a, 70b of the heat pump cycle 10, and can control the degree of pressure reduction of the refrigerant by adjusting the opening degrees of the expansion valves 70a, 70b. Furthermore, the control unit 40 is connected to a power source for applying a voltage to the pair of electrodes 107, 108 of the heating portion 100, and the power source can be controlled to adjust the heating state of the honeycomb structure. The power source is not particularly limited, and a battery or the like can be used.

The control unit 110 is electrically connected to a ventilation fan 130, an air mix door 140, and the like, in addition to the heat pump cycle 10 and the heating portion 100, and it can control these members.

The control unit 110 is generally an ECU (Engine (electronic) Control Unit), although not particularly limited thereto. The ECU includes a CPU for performing various calculation processes, a ROM for storing programs and data required for its control, a RAM for temporarily storing results of calculations performed by the CPU, and input/output ports for inputting and outputting signals to and from the outside.

### (4. Ventilation Fan 130)

The ventilation fan 130 is provided to circulate the air through the air conditioning duct 120. The ventilation fan 130 is not particularly limited, and any known ventilation fan can be used.

The position of the ventilation fan 130 is not particularly limited, and it may be provided on an upstream side of the condenser 40 or the evaporator 50. However, the ventilation fan 130 may be provided on a downstream side of the condenser 40 or the evaporator 50.

### (5. Air Mix Door 140)

The air mix door 140 is configured to rotate in the air conditioning duct 120 between a heating position that opens a heating path toward the condenser 40 and a cooling position that opens a cooling path that bypasses the condenser 40. Furthermore, by rotating the air mix door 140 between the heating position and the cooling position, it can adjust a ratio of the air passing through the condenser 40 to the air bypassing the condenser 40, thereby adjusting the temperature of the air flowing into the vehicle interior.

In the air conditioning system according to the embodiment of the present invention, the operation mode of the heat pump cycle 10 can include a heating operation mode and a cooling operation mode. The operation mode of the heat pump cycle 10 can be selected depending on switch operations by the driver, temperature changes detected by various detection units, and the like.

### (A) Heating Operation Mode

As shown in FIG. 1A, the heating operation mode opens the shutoff valves 80a to 80c and closes the shutoff valves 80d and 80e, thereby forming a flow path such that the refrigerant sequentially flows through the compressor 30, the condenser 40, the expansion valve 70a, and the outdoor heat exchanger 60. It should be noted that, in FIG. 1A, the flow path through which the refrigerant flows in this heating operation mode is shown by a thicker line.

This heating operation mode includes compressing the refrigerant with compressor 30 and introducing the refrigerant discharged from compressor 30 into condenser 40 to heat the air. That is, the refrigerant compressed by the compressor 30 enters the condenser 40 as a high-temperature, high-pressure refrigerant, exchanges heat with the air flowing in the air conditioning duct 120, and releases the heat (heats the air). The refrigerant leaving the condenser 40 is pressure-reduced and expanded by the expansion valve 70a to form a low-temperature, low-pressure refrigerant, and then exchanges the heat with the outside air in the outdoor heat exchanger 60 to absorb the heat, and returns to the compressor 30.

When this heating operation mode is performed, the air flowing through the air conditioning duct 120 is heated by the condenser 40, and the heated air flows into the vehicle interior. The temperature of the air flowing into the vehicle interior can be adjusted by controlling the opening degree of the air mix door 140.

Further, when the heating operation mode is started, the control unit 110 includes controlling so that the refrigerant is heated by applying a voltage to the honeycomb structure making up the heating portion 100. Such controlling allows the refrigerant to be rapidly heated even if the temperature of the refrigerant in the heat pump cycle 10 is low in cold weather, so that the initial heating performance can be improved.

### (B) First Cooling Operation Mode

As shown in FIG. 1B, the first cooling operation mode opens the shutoff valves 80a, 80d, 80e and closes the shutoff valves 80b, 80c, thereby forming a flow path such that the refrigerant sequentially flows through the compressor 30, the outdoor heat exchanger 60, the expansion valve 70b and the evaporator 50. It should be noted that, in FIG. 1B, the flow path through which the refrigerant flows in this cooling operation mode is shown by a thicker line.

This cooling operation mode includes introducing the refrigerant decompressed and expanded by the expansion valve 70b into the evaporator 50 to cool the air. That is, the refrigerant compressed by the compressor 30 to a high temperature and a high pressure is cooled by exchanging heat with the outside air and releasing the heat in the outdoor heat exchanger 60. The refrigerant leaving the outdoor heat exchanger 60 is pressure-reduced and expanded by the expansion valve 70b to form a low-temperature and low-pressure refrigerant, which enters the evaporator 50, and exchanges the heat with the air flowing through the air conditioning duct 120 to absorb the heat (cool the air). The refrigerant leaving the evaporator 50 returns to the compressor 30.

When the cooling operation mode is performed, the air flowing through the air conditioning duct 120 is cooled by the evaporator 50, and the cooled air flows into the vehicle interior. The cooling operation mode is particularly useful when it is desired to rapidly cool the vehicle interior (strong cooling operation mode).

### (C) Second Cooling Operation Mode

As shown in FIG. 1C, the second cooling operation mode opens the shutoff valves 80a, 80c, 80e and closes the shutoff valves 80b, 80d, thereby forming a flow path such that the refrigerant sequentially flows through the compressor 30, the condenser 40, the expansion valve 70a, the outdoor heat exchanger 60, the expansion valve 70b, and the evaporator 50. It should be noted that, in FIG. 1C, the flow path through which the refrigerant flows in this cooling operation mode is shown by a thicker line.

The condenser 40 and the expansion valve 70a are further disposed on a downstream side of the compressor 30 in the refrigerant flow path in this cooling operation mode. In the cooling operation mode, the cooling of the air by the evaporator 50 and the heating of the air by the condenser 40 can be adjusted by controlling the opening degree of the air mix door 140, so that the temperature of the air can be controlled to the optimum temperature.

### DESCRIPTION OF REFERENCE NUMERALS

10 heat pump cycle
20 refrigerant pipe
30 compressor
40 condenser
50 evaporator
60 outdoor heat exchanger
70a, 70b expansion valve
80a, 80b, 80c, 80d, 80e shut-off valve
100 heating portion
101 outer peripheral wall
102 first end face
103 second end face
104 cell
105 partition wall
106 inner peripheral wall
107, 108 electrodes
110 control unit
120 air conditioning duct
130 ventilation fan
140 air mix door

1. An air conditioning system comprising a heat pump cycle having a refrigerant pipe capable of circulating a refrigerant therethrough, and a compressor capable of compressing the refrigerant, wherein:
the air conditioning system is provided with at least one heating portion capable of heating the refrigerant in the refrigerant pipe on an upstream side, a downstream side, or both of the upstream side and the downstream side of the compressor based on a flow direction of the refrigerant; and
the heating portion comprises: a honeycomb structure having an outer peripheral wall and partition walls disposed on an inner side of the outer peripheral wall, the partition walls defining a plurality of cells, each of the cells extending from a first end face to a second end face, at least the partition walls being made of a material having a PTC property.

2. The air conditioning system according to claim 1, wherein the air conditioning system further comprises a control unit for controlling the heat pump cycle and the heating portion, and wherein the control unit comprises controlling so as to apply a voltage to the honeycomb structure to heat the refrigerant upon start of a heating operation mode of the heat pump cycle.

3. The air conditioning system according to claim 2,
wherein the heat pump cycle further comprises a condenser for exchanging heat between air flowing through an air conditioning duct and the refrigerant, and
wherein the heating operation mode comprises compressing the refrigerant by the compressor and introducing the refrigerant discharged from the compressor into the condenser to heat the air.

4. The air conditioning system according to claim 3, wherein the heat pump cycle further comprises:
an evaporator for exchanging heat between the air flowing through the air conditioning duct and the refrigerant; and
an outdoor heat exchanger for exchanging heat between outside air and the refrigerant.

5. The air conditioning system according to claim 4, wherein the heating portion is provided in the refrigerant pipe at a position between the compressor and the condenser, or at a position between the compressor and the evaporator or the outdoor heat exchanger, or the heat portions are provided in the refrigerant pipe at both of the positions.

6. The air conditioning system according to claim 1, wherein the material having the PTC property comprises barium titanate as a main component.

7. The air conditioning system according to claim 1, wherein the air conditioning system is for a vehicle.
